(19) United States
(12) Patent Application Publication
(10) Pub. No.: US 2016/0255228 A1
(43) Pub. Date: Sep. 1, 2016

(54) POWER CONTROLLER, NON-TRANSITORY COMPUTER READABLE MEDIUM, AND IMAGE FORMING APPARATUS

(71) Applicant: FUJI XEROX CO., LTD., Tokyo (JP)

(72) Inventors: Suguru OUE, Kanagawa (JP); Tomoki TANIHATA, Kanagawa (JP); Tomoyuki ONO, Kanagawa (JP)

(73) Assignee: FUJI XEROX CO., LTD., Tokyo (JP)

(21) Appl. No.: 14/844,186

(22) Filed: Sep. 3, 2015

(30) Foreign Application Priority Data
Feb. 26, 2015 (JP) 2015-037241

(51) Int. Cl. H04N 1/00; G06K 9/00

(52) U.S. Cl. CPC H04N 1/00891; G06K 9/00342; H04N 1/00307; H04N 2201/0055

(57) ABSTRACT

A power controller includes a detector and a controller. The detector detects a movement of a user through wireless communication. The controller controls transition to a power-saving mode and recovery from the power-saving mode and performs control for the recovery from the power-saving mode in a case where the detector detects a movement of approach of the user in the power-saving mode.

### CROSS-REFERENCE TO RELATED APPLICATIONS

This application is based on and claims priority under 35 USC 119 from Japanese Patent Application No. 2015-037241 filed Feb. 26, 2015.

### BACKGROUND

### Technical Field

The present invention relates to a power controller, a non-transitory computer readable medium, and an image forming apparatus.

### SUMMARY

According to an aspect of the invention, there is provided a power controller including a detector and a controller. The detector detects a movement of a user through wireless communication. The controller controls transition to a power-saving mode and recovery from the power-saving mode and performs control for the recovery from the power-saving mode in a case where the detector detects a movement of approach of the user in the power-saving mode.

### BRIEF DESCRIPTION OF THE DRAWINGS

An exemplary embodiment of the present invention will be described in detail based on the following figures, wherein:

FIG. 1 is a configuration diagram illustrating the exemplary embodiment of the present invention;

FIG. 2 is a chart for explaining an example of information that is held to identify a user;

FIGS. 3A and 3B are flowcharts illustrating an example of operations in the exemplary embodiment of the present invention;

FIGS. 4A, 4B, and 4C are graphs for explaining an example of a method for determining whether a user is approaching;

FIGS. 5A, 5B, 5C, and 5D are diagrams for explaining specific examples of the operations in the exemplary embodiment of the present invention;

FIG. 6 is a diagram for explaining an example of application of the exemplary embodiment of the present invention; and

FIG. 7 is a diagram for explaining an example of a computer program and storage media storing the computer program therein, the computer program implementing functions of apparatuses explained in the exemplary embodiment of the present invention and the application example.

### DETAILED DESCRIPTION

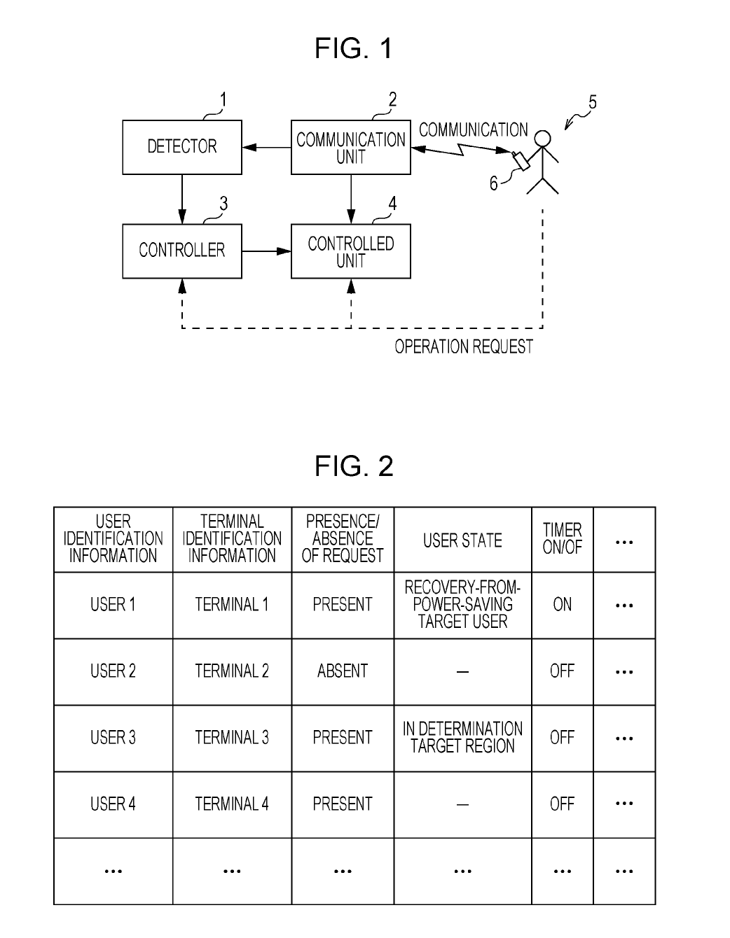

FIG. 1 is a configuration diagram illustrating an exemplary embodiment of the present invention. In FIG. 1, reference numeral 1 denotes a detector; 2, a communication unit; 3, a controller; 4, a controlled unit; 5, one of users; and 6, one of communication terminals. The detector 1 detects a movement of the user 5 such as the approach, withdrawal, or stoppage of the user 5. The detection method is not limited, and for example, a change in the strength of a sound wave, a radio wave, light, or the like may be used to detect a movement of the user 5 such as the approach, withdrawal, or stoppage.

FIG. 1 illustrates an example in which the communication unit 2 is used for the detection. The communication unit 2 may be provided as a component that detects the movement of the user 5. Alternatively, a communication unit used by the controlled unit 4 may also be used for the detection of the movement of the user 5. For example, suppose a case where the user 5 carries the communication terminal 6 with the user 5 and where the communication unit 2 communicates with the communication terminal 6. In this case, variation in reception strength of a radio wave from the communication terminal 6 may be used to detect a movement of the user 5, for example, whether the user 5 is approaching, withdrawing, or has stopped. Examples of the communication terminal 6 include a smartphone, a mobile phone, and a card equipped with a wireless communication integrated circuit (IC).

In the example in FIG. 1, the controller 3 controls transition and recovery of the controlled unit 4 to and from a power-saving mode. If the detector 1 detects the movement of approach of a user, the controller 3 performs control to cause the controlled unit 4 to recover from the power-saving mode and to start processing related to a request from the user. At this time, the controller 3 may perform the control in the following manner. Specifically, the controller 3 determines whether the user is a user who has in advance transmitted a request for operations of the controlled unit 4 and the controller 3. If the user has transmitted the operation request, and if the detector 1 detects the movement of approach of the user, the controller 3 causes the controlled unit 4 to recover from the power-saving mode and to start the processing related to the request from the user. In addition, if the controlled unit 4 has recovered from the power-saving mode, and if a predetermined time has elapsed after the movement of approach of a user for whom the recovery is to be performed is not detected any more due to, for example, start of withdrawal or stoppage, the controller may perform the control to cause the controlled unit 4 to transition to the power-saving mode.

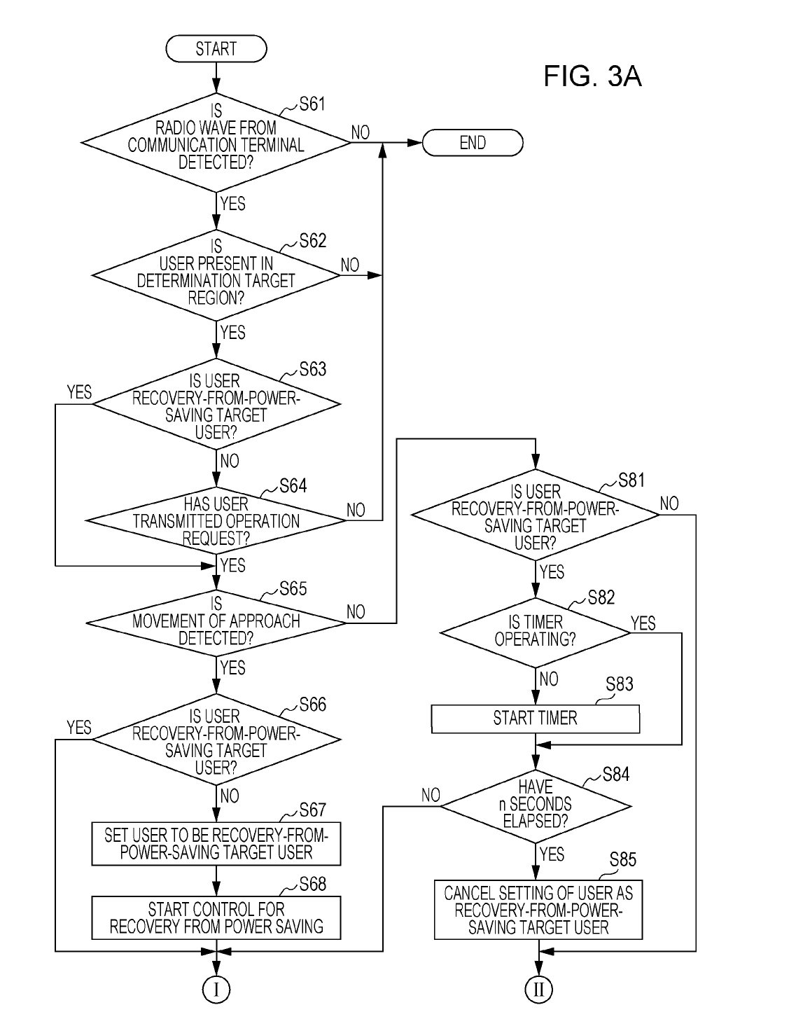

To identify a user in a case where, for example, an operation request is received, associated information may be held in advance. Specifically, information identifying a user (hereinafter, referred to as user identification information) is associated with information identifying the communication terminal 6 (hereinafter, referred to as terminal identification information) carried by the user, the terminal identification information being acquired from the communication terminal 6 by the communication unit 2. FIG. 2 is a chart for explaining an example of information that is held to identify a user. In the example, the user identification information is associated with not only the terminal identification information but also information indicating whether a request is present (request-presence information) and information indicating a user movement state (user-state information). In this example, the user identification information is also associated with timer information that is an example of another piece of information. The user-state information may indicate a state related to a user, such as a state in which the communication unit 2 becomes ready to communicate with the communication terminal 6 of the user, a state in which the user has approached and recovery from the power-saving mode is to be performed for the user, and a state in which the user is using the controlled unit 4. It goes without saying that the example of the associated information is not limited to this example, and various pieces of information may be associated with each other. In addition to the pieces of information described above, information for registering a user having transmitted a request and other pieces of information may be held.

When an operation request is received, user identification information regarding a user who has transmitted the request is acquired. Thereafter, when the communication unit 2 communicates with a communication terminal 6, the terminal identification information of the communication terminal 6 is acquired from the communication terminal 6. If an operation request has been received from a user whose user identification information is associated with the terminal identification information thus acquired from the communication terminal 6, the control for recovery from the power-saving mode may be performed for the user. To determine whether the operation request has been received from the user, the information indicating the request-presence information that is associated with the user identification information and the terminal identification information may be referred to in the example in FIG. 2. If a user 5 who has not transmitted an operation request approaches with the communication terminal 6 carried by the user 5, the control for recovery from the power-saving mode is not performed, and the controlled unit 4 remains in the power-saving mode.

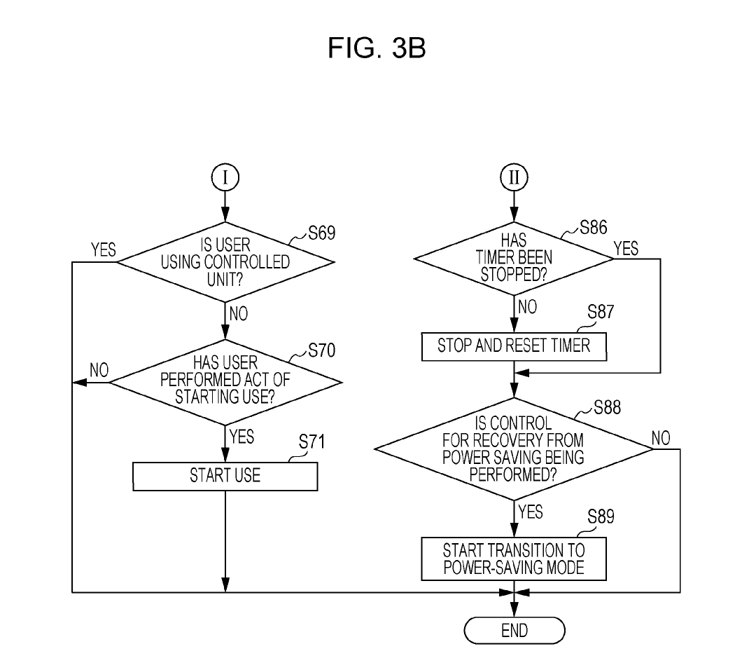

FIGS. 3A and 3B are flowcharts illustrating an example of operations in the exemplary embodiment of the present invention. In the example, the communication unit 2 is provided, which communicates with a communication terminal 6 carried by a user 5. In addition, the information illustrated in FIG. 2 is held or referred to by the controller 3. Further, the example of the operations illustrates a case where a user is authenticated before using the controlled unit 4. Processing illustrated in the example of operations is repeated at predetermined intervals or at predetermined timing.

In step S61, it is determined whether the communication unit 2 has detected a radio wave transmitted from the communication terminal 6 carried by the user 5. If the communication unit 2 has not detected the radio wave, the determination result indicates that the user 5 is not present in a radio-wave detection range of the communication unit 2. The processing is terminated without subsequent operations.

In step S62, it is determined whether the user 5 is present in a predetermined region (hereinafter, a determination target region) in the example of operations. The determination target region may be, for example, a region within which the strength of a radio wave received by the communication unit 2 is equal to or higher than a predetermined strength. It goes without saying that the determination target region may be a region within which the communication unit 2 detects a radio wave transmitted from the communication terminal 6, so that the determination in step S62 does not have to be performed. If the user 5 is not present in the determination target region, the processing is terminated.

In step S63, it is determined whether the user 5 carrying the communication terminal 6 with which the communication unit 2 is communicating is a user for whom recovery from the power-saving mode is to be performed (hereinafter, referred to as a recovery-from-power-saving target user). In the determination, for example, the information illustrated in FIG. 2 may be used, and it may be determined whether the user-state information associated with the terminal identification information acquired by the communication unit 2 indicates a recovery-from-power-saving target user. If the user-state information indicates a recovery-from-power-saving target user, the determination in step S64 is omitted, and the processing proceeds to S65.

In step S64, it is determined whether the user 5 carrying the communication terminal 6 with which the communication unit 2 is communicating has transmitted an operation request. In the determination, for example, the information illustrated in FIG. 2 may be used, and reference may be made to the request-presence information associated with the terminal identification information acquired by the communication unit 2. Alternatively, a list of users who have transmitted the operation request may be searched to find the user 5 of the communication terminal 6. If the user 5 has not transmitted the operation request, it is determined that the user 5 does not use an apparatus including the controlled unit 4. The recovery from the power-saving mode is not performed, and the processing is terminated.

In step S65, it is determined whether the detector 1 has detected a movement of approach of the user 5 carrying the communication terminal 6 with which the communication unit 2 is communicating. In the determination, it is not simply determined whether the user 5 is present near the apparatus but is determined whether the user 5 is approaching, that is, the movement of the user 5 is determined.

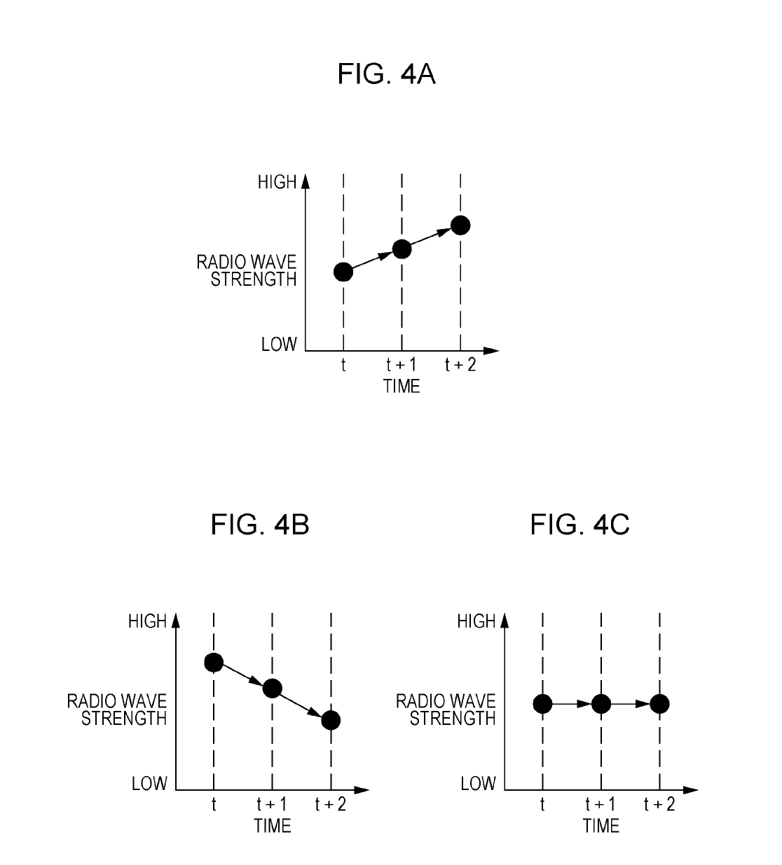

FIGS. 4A, 4B, and 4C are graphs for explaining an example of a method for determining whether a user is approaching. In a method for determining whether a user is approaching, a change in the strength of a radio wave is used, the radio wave being received by the communication unit 2 from a communication terminal 6 carried by a user 5. FIGS. 4A, 4B, and 4C each illustrate a relationship between time and radio wave strength. In the example illustrated in FIG. 4A, the radio wave strength becomes high with the elapse of time. In this case, it is determined that the user 5 is approaching. In the example illustrated in FIG. 4B, the radio wave strength becomes low with the elapse of time. In this case, it is estimated that the user 5 is withdrawing, and it is not determined that the user 5 is approaching. The example illustrated in FIG. 4C exhibits little change in radio wave strength despite the elapse of time. In this case, it is estimated that the user 5 has stopped. It is not determined that the user 5 is approaching because the time might elapse with the controlled unit 4 being still not in use. It goes without saying that the determination method is only an example, and another method may be used to determine whether a user is approaching.

Referring back to FIG. 3A, if it is determined in step S65 that the user 5 is approaching, it is determined whether the user 5 is a recovery-from-power-saving target user. In the determination, for example, the information illustrated in FIG. 2 may be used, and it may be determined whether the user-state information indicates a recovery-from-power-saving target user. If the user-state information indicates a recovery-from-power-saving target user, steps S67 and S68 are omitted, and the processing proceeds to S69.

If it is determined in step S66 that the user 5 is not a recovery-from-power-saving target user, the user 5 is set to be a recovery-from-power-saving target user in step S67. For example, in the information illustrated in FIG. 2, information indicating a recovery-from-power-saving target user may be set in the user-state information corresponding to the user 5. If the controlled unit 4 is in the power-saving mode, the control for causing the controlled unit 4 to recover from the power-saving mode is started in step S68.

In step S69, it is determined whether the user 5 is using the controlled unit 4. In the determination, for example, the information illustrated in FIG. 2 may be used, and it may be determined whether the user-state information indicates that the controlled unit 4 is being used. If the user-state information indicates that the controlled unit 4 is being used, the use state of the controlled unit 4 is maintained without subsequent operations, and the processing is terminated.

If the user 5 is not using the controlled unit 4, it is determined in step S70 whether the user 5 has performed an act of starting the use of the controlled unit 4. The act of starting the use may be any of various known acts of starting the use such as performing an operation of using the controlled unit 4 and performing an authentication operation. If the user 5 has performed the act of starting the use, the use of the controlled unit 4 by the user 5 is started in step S71. In addition, for example, on the assumption that the information illustrated in FIG. 2 is used, the user-state information is changed to a state indicating that the user 5 is using the controlled unit 4. The user thereafter uses the controlled unit 4, and the processing is terminated. If it is determined in step S70 that the user has not performed an act of starting the use of the controlled unit 4, it is considered that the user 5 is approaching but has not used the controlled unit 4 yet, and the processing is terminated without subsequent operations.

If it is determined in step S65 that the user 5 carrying the communication terminal 6 with which the communication unit 2 is communicating is not approaching, it is determined in step S81 whether the user 5 is a recovery-from-power-saving target user. In the determination, for example, the information illustrated in FIG. 2 may be used, and it may be determined whether the user-state information associated with the terminal identification information acquired by the communication unit 2 indicates that the user 5 is a recovery-from-power-saving target user. If it is determined that the user 5 is not a recovery-from-power-saving target user, steps related to time elapse determination from S82 to S85 are omitted, and the processing proceeds to S86.

If it is determined in step S81 that the user 5 is a recovery-from-power-saving target user, the determination result indicates a case where the user 5 has approached but stopped or withdrawn. In this case, even though the movement of approach is not detected any more, the setting of the user 5 as a recovery-from-power-saving target user is maintained until a predetermined time elapses. This is because, for example, the user 5 might have stopped in front of the controlled unit 4 intending to use the controlled unit 4. In the example of operations, it is determined in step S82 whether a timer is operating. If the timer is operating, the processing proceeds to S84. If the timer is not operating, the timer is started in step S83, and the processing proceeds to S84.

In step S84, it is determined whether the predetermined time (n seconds) has elapsed on the basis of the timer. If the predetermined time has not elapsed yet, the setting of the user 5 as a recovery-from-power-saving target user is maintained, and the processing proceeds to S69.

If it is determined in step S84 that the predetermined time has elapsed, it is determined that the user 5 does not use the controlled unit 4. In this case, the setting of the user 5 as a recovery-from-power-saving target user is cancelled in step S85. For example, the information illustrated in FIG. 2 may be used, and the user-state information may be changed to a state indicating a communication-ready state.

In step S86, it is determined whether the timer has been stopped. If the timer has been stopped, the processing proceeds to S88. If the timer has not been stopped, the timer is stopped and reset in step S87, and the processing proceeds to S88.

In step S88, it is determined whether the control for recovery from the power-saving mode is being performed. If the controlled unit 4 is in the power-saving mode, the processing is terminated without subsequent operations. If the control for recovery from the power-saving mode has been started, transition to the power-saving mode is started in step S89.

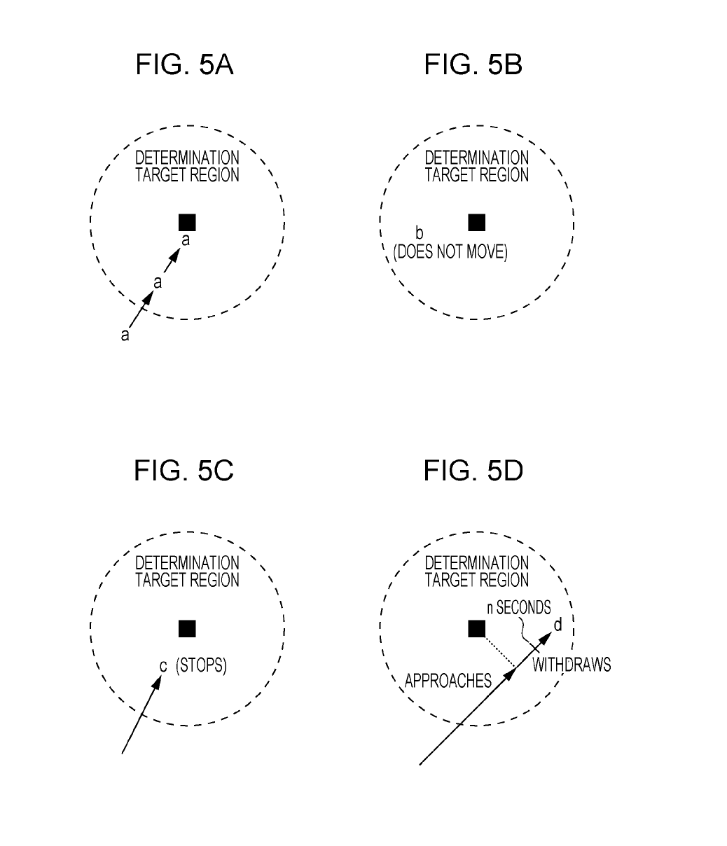

FIGS. 5A, 5B, 5C, and 5D are diagrams for explaining specific examples of the operations in the exemplary embodiment of the present invention. The foregoing example of operations will further be described by using the specific examples. FIG. 5A illustrates a case where a user a transmits an operation request and approaches with his/her communication terminal 6 carried by the user a. When the communication terminal 6 enters a communication range of the communication unit 2, the communication unit 2 recognizes the communication terminal 6. When the user a further approaches and enters the determination target region, the user a is set to be a recovery-from-power-saving target user in step S67 in FIG. 3A, and then the control for causing the controlled unit 4 to recover from the power-saving mode is started.

When the user a approaches further and stops in front of the apparatus, the movement of approach is not detected any more. However, the setting of the user a as a recovery-from-power-saving target user is maintained until the predetermined time elapses after the timer is started in step S83 in FIG. 3A. If the act of starting the use is performed within the predetermined time, the use of the controlled unit 4 is started in step S71 in FIG. 3B. While the controlled unit 4 is being used, the operation of recovery from the power-saving mode illustrated in FIG. 3A is not performed, and transition to the power-saving mode does not occur. After the use is completed, the operation request is deleted. The user a is thereafter regarded as a user who has not transmitted an operation request. In addition, after the use is completed, or after a predetermined time elapses after the completion, control for transition to the power-saving mode is performed, and the operation of recovery from the power-saving mode illustrated in FIG. 3A is performed again as appropriate.

FIG. 5B illustrates a user b who works at his/her workdesk in the determination target region. If the user b carries his/her communication terminal 6, the communication unit 2 communicates with the communication terminal 6 and detects the presence of the user b in the determination target region. However, the user b has not transmitted an operation request. Accordingly, the user b is not set to be a recovery-from-power-saving target user, and the controlled unit 4 is not caused to recover from the power-saving mode. Even if the user b transmits an operation request, the controlled unit 4 is not caused to recover from the power-saving mode because the movement of approach of the user b is not detected as long as the user b is present at the workdesk. The power-saving mode is thus maintained, and power saving is continued.

FIG. 5C illustrates that a user c transmits an operation request and thereafter approaches with his/her communication terminal 6 carried by the user c. When the user c approaches and enters the determination target region, the user c is set to be a recovery-from-power-saving target user in step S67 in FIG. 3A, and the control for causing the controlled unit 4 to recover from the power-saving mode is started. However, in this example, the user c has stopped. In this case, the movement of approach is not detected any more because the user c has stopped, and the timer is started in step S83 in FIG. 3A. If the user c remains stopped even after the predetermined time elapses, the setting of the user c as a recovery-from-power-saving target user is cancelled in step S85 in FIG. 3A, and the control for causing the controlled unit 4 to transition to the power-saving mode is performed in step S89. This minimizes the occurrence of the operation of recovery from power saving and a period of time of recovery from power saving. If the movement of approach of the user c is thereafter resumed, the user c is again set to be a recovery-from-power-saving target user, and the control for causing the controlled unit 4 to recover from the power-saving mode is started.

FIG. 5D illustrates a case where a user d transmits an operation request and passes through the determination target region with his/her communication terminal 6. Also in this case, when the user d is approaching in the determination target region, the user d is set to be a recovery-from-power-saving target user in step S67 in FIG. 3A, and the control for recovery of the controlled unit 4 from the power-saving mode is thus started. However, the user d withdraws after the closest approach. When the user d starts withdrawing, the movement of approach is not detected any more, and thus the timer is started. If the predetermined time elapses, the setting of the user d as a recovery-from-power-saving target user is cancelled in step S85 in FIG. 3A, and the control for causing the controlled unit 4 to transition to the power-saving mode is performed in step S89. Also in the case of a user who just passes through the determination target region, this minimizes the occurrence of the operation of recovery from power saving and a period of time of recovery from power saving.

In a case of approach of a user who carries his/her communication terminal 6 but has not transmitted an operation request, steps after the determination in step S64 in FIG. 3A are not performed. Accordingly, the approach of the user who has not transmitted the operation request does not cause the recovery from the power-saving mode, and the power-saving mode is maintained.

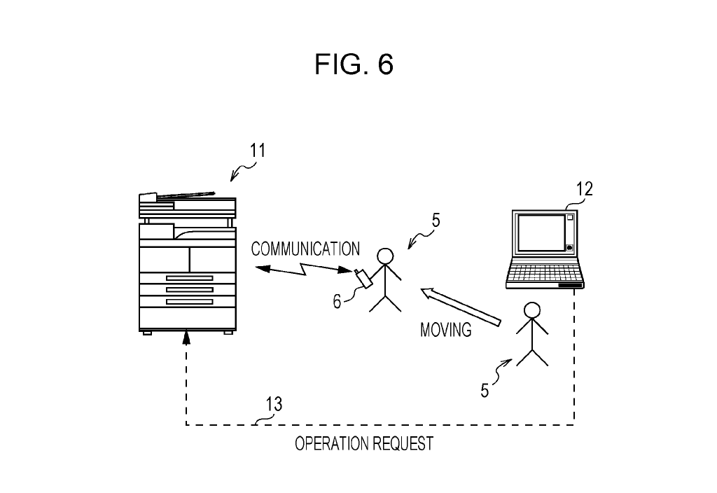

FIG. 6 is a diagram for explaining an example of application of the exemplary embodiment of the present invention. In FIG. 6, reference numeral 11 denotes an image forming apparatus; 12, a terminal apparatus; and 13, a communication path. FIG. 6 illustrates the image forming apparatus 11 as an application example that includes the components illustrated in FIG. 1. The image forming apparatus 11 includes the detector 1, the communication unit 2, the controller 3, and an image forming unit (not illustrated) serving as the controlled unit 4. The image forming apparatus 11 also includes a receiving unit that receives an image forming request as an operation request. The image forming apparatus 11 causes the receiving unit to receive the image forming request, for example, through the communication path 13, acquires information for forming an image through the communication path 13 in response to the received image forming request, generates an image, causes the image forming unit to form the image on a medium such as paper, and outputs the image. To save power in the power-saving mode, power supply to the image forming unit may be stopped, or a smaller amount of power may be supplied than in a normal operation mode. Further, processing of generating an image to be formed on the medium or other processing may be stopped, or communication performed through the communication path 13 may be minimized.

In this example, the user 5 transmits an image forming request to the image forming apparatus 11 by using the terminal apparatus 12 through the communication path 13. The information for forming an image may be transmitted from the terminal apparatus 12 to the image forming apparatus 11 or may be transferred to a server connected to the communication path 13. Alternatively, information that is not held in the terminal apparatus 12 may be used to give an instruction for forming an image. Another configuration may also be used in which an image forming request is transmitted to the image forming apparatus 11 from the communication terminal 6 carried by the user 5, without using the terminal apparatus 12. When the image forming request is transmitted, user identification information is added to the image forming request.

Meanwhile, suppose a case where multiple users share the image forming apparatus 11. After the image forming apparatus 11 forms and outputs an image on a medium on the basis of information, the output medium having the image formed thereon might be taken away by a user who has not transmitted the request for forming the image. In this case, confidentiality is impaired. To avoid this, a method in which a user performs an authentication operation on the image forming apparatus 11 and an image is thereafter formed and output has been used. In this case, if the image forming apparatus 11 is in the power-saving mode, performing the control for recovery from the power-saving mode after the authentication causes the user to wait. In some cases, the authentication is completed in a short time in a simple operation such as bringing the communication terminal 6 or an IC card close to a reading unit. Accordingly, even if the image forming apparatus 11 is caused to recover from the power-saving mode upon start of the authentication, the user is caused to wait.

In the exemplary embodiment described above, when the user 5 approaches the image forming apparatus 11 with the communication terminal 6 carried by the user 5 after transmitting an image forming request, the detector 1 detects the movement of approach of the user 5 on the basis of the strength or the like of a radio wave received by the communication unit 2, and the image forming apparatus 11 starts recovery from the power-saving mode. It is assumed that by the time the user 5 performs the authentication on the image forming apparatus 11, the recovery from the power-saving mode will have been completed or progressed to a certain extent. As described above, the processing of recovery from the power-saving mode has been started before the authentication, and a period of time when the user 5 waits is thus reduced in comparison with the case where the recovery from the power-saving mode is performed after the authentication. Even though the image forming apparatus 11 recovers from the power-saving mode before the authentication, an image is formed and output after the authentication. Accordingly, another user does not take away the output medium, and thus the confidentiality is ensured.

Note that even if a user has transmitted an image forming request but if the predetermined time elapses after the movement of approach of the user is not detected any more, the control for recovery from the power-saving mode is stopped, and the image forming apparatus 11 transitions to the power-saving mode. This occurs, for example, in a case where the user has stopped, stands and talks, or in a case where the user approaches the image forming apparatus 11 in the course of moving to another place. In such cases, the recovery from the power-saving mode is started once, but the image forming apparatus 11 transitions to the power-saving mode again on condition that the predetermined time elapses after the approach is not detected any more. Unnecessary power consumption is thus reduced.

Incidentally, also suppose a case where a user has not transmitted an image forming request. Even though the user carries his/her communication terminal 6, the image forming apparatus 11 naturally does not recover from the power-saving mode and remains in the power-saving mode.

In the description above, the image forming apparatus has the function of forming and outputting an image on a medium, but the configuration of the image forming apparatus is not limited to this. For example, the image forming apparatus may include an image reading unit or may further have a facsimile communication function. In addition, the example of application to the image forming apparatus has herein been described but is not limited to this. It goes without saying that the exemplary embodiment is applicable to any of various apparatuses that transition to and recover from the power-saving mode.

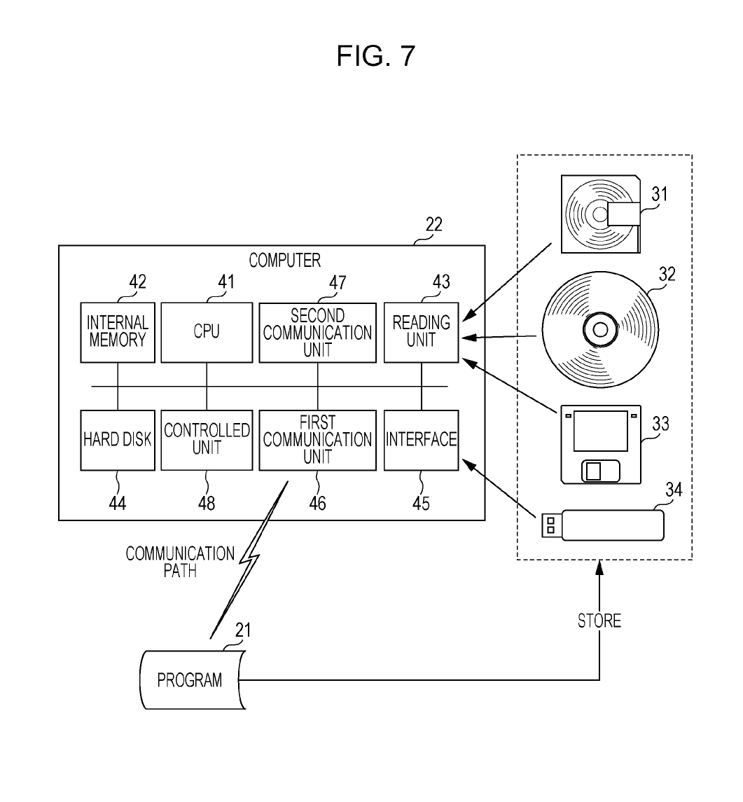

FIG. 7 is a diagram for explaining an example of a computer program and a storage media storing the computer program therein, the computer program implementing functions of the apparatuses explained in the exemplary embodiment of the present invention and the application example. In FIG. 7, reference numeral 21 denotes a program; 22, a computer; 31, a magneto-optical disk; 32, an optical disk; 33, a magnetic disk; 34, a memory; 41, a CPU; 42, an internal memory; 43, a reading unit; 44, a hard disk; 45, an interface; 46, a first communication unit; 47, a second communication unit; and 48, a controlled unit.

All or some of the functions of the apparatuses described in the exemplary embodiment of the present invention and the application example that are described above may be implemented by the program 21 run by a computer. In this case, the program 21, data used by the program 21, and the like may be stored in a storage medium read by the computer. The storage medium is used to transmit the description content of the program to the reading unit 43 included in hardware resources of the computer. The description content of the program is transmitted in a signal format corresponding to a state of a change in energy of such as magnetism, light, or electricity that is caused in the reading unit 43 in accordance with the description content of the program. Examples of the storage medium include the magneto-optical disc 31, the optical disc 32 (including a compact disc (CD), a digital versatile disc (DVD), and the like), the magnetic disc 33, and the memory 34 (including an IC card, a memory card, a flash memory, and the like). It goes without saying that the storage media are not limited to portable media.

The program 21 has been stored in any one of the storage media. The storage medium is attached to, for example, the reading unit 43 or the interface 45 of the computer 22. The program 21 is read from the computer 22, then stored in the internal memory 42 or the hard disk 44 (including the magnetic disk, a silicon disk, and the like), and run by the CPU 41. All or some of the functions of the apparatuses described above in the exemplary embodiment of the present invention and the application example are thereby implemented. Alternatively, all or some of the functions may be implemented in such a manner that the program 21 is transferred to the computer 22 through a communication path. In the computer 22, the program 21 is received by the first communication unit 46, stored in the internal memory 42 or the hard disk 44, and run by the CPU 41.

The various pieces of information, for example, illustrated in FIG. 2 may be stored in the internal memory 42, the hard disk 44, or the like. In a case where user registration information is stored in the internal memory 42, a nonvolatile memory region in which data is not erased despite power disconnection may be used to store the user registration information.

To the computer 22, the second communication unit 47 and the controlled unit 48 respectively corresponding to the communication unit 2 and the controlled unit 4 illustrated in FIG. 1 are connected. As the controlled unit 48, the image forming unit in the foregoing example of application of the exemplary embodiment is connected to the computer 22. The second communication unit 47 and the controlled unit 48 may be connected to a bus directly or through the interface 45. One communication unit may serve as the first communication unit 46 and the second communication unit 47.

Moreover, various apparatuses may be connected to the bus through the interface 45. Examples of the various apparatuses include a communication apparatus that performs user authentication, a receiving unit that receives various key inputs performed through user operations, and a display that presents various pieces of information to a user and that further presents in advance an image to be formed. The various apparatuses may be connected to the bus through the interface 45 or directly. Note that the components do not have to be operated in one computer.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A power controller comprising:
a detector that detects a movement of a user through wireless communication; and
a controller that controls transition to a power-saving mode and recovery from the power-saving mode and that performs control for the recovery from the power-saving mode in a case where the detector detects a movement of approach of the user in the power-saving mode.

2. The power controller according to claim 1,
wherein when a movement of approach of a user who has in advance transmitted a request for an operation is detected in a designated region, the controller performs control for the recovery from the power-saving mode and for starting processing related to the request from the user.

3. The power controller according to claim 1,
wherein if a predetermined time elapses after a movement of approach of a user for whom the recovery from the power-saving mode is to be performed is not detected any more, the controller performs control for the transition to the power-saving mode.

4. The power controller according to claim 2,
wherein if a predetermined time elapses after a movement of a user for whom the recovery from the power-saving mode is to be performed is not detected any more, the controller performs control for the transition to the power-saving mode.

5. The power controller according to claim 1, further comprising:
a communication unit that communicates with a communication terminal carried by the user,
wherein the detector detects the movement of the user on a basis of strength variation in reception performed by the communication unit.

6. The power controller according to claim 2, further comprising:
a communication unit that communicates with a communication terminal carried by the user,
wherein the detector detects the movement of the user on a basis of strength variation in reception performed by the communication unit.

7. The power controller according to claim 3, further comprising:
a communication unit that communicates with a communication terminal carried by the user,
wherein the detector detects the movement of the user on a basis of strength variation in reception performed by the communication unit.

8. The power controller according to claim 4, further comprising:
a communication unit that communicates with a communication terminal carried by the user,
wherein the detector detects the movement of the user on a basis of strength variation in reception performed by the communication unit.

9. A non-transitory computer readable medium storing a program causing a computer to execute a function of the power controller according to claim 1.

10. An image forming apparatus comprising:
a forming unit that forms an image;
a receiving unit that receives a request for image formation to be performed by the forming unit; and
the power controller according to claim 1,
wherein the power controller performs control for power saving on the forming unit on a basis of presence or absence of approach of a user who has transmitted the request for image formation received by the receiving unit.
